(19) United States
(12) Patent Application Publication
(10) Pub. No.: US 2026/0208517 A1
(43) Pub. Date: Jul. 23, 2026

(54) LIQUID DROPLET DISCHARGE HEAD

(71) Applicant: KYOCERA Corporation, Kyoto (JP)

(72) Inventors: Masaru IWABUCHI, Kirishima-shi, Kagoshima (JP); Fumito NAKAMOTO, Kirishima-shi, Kagoshima (JP); Naoto MIYAKOSHI, Osaka-shi, Osaka (JP)

(21) Appl. No.: 19/141,050

(22) PCT Filed: Dec. 28, 2023
(86) PCT No.: PCT/JP2023/047355

§ 371 Date: Jun. 19, 2025

(30) Foreign Application Priority Data
Dec. 28, 2022 (JP) 2022-212433

(51) Int. Cl. B41J 29/377; B41J 2/045; B41J 2/14

(52) U.S. Cl. CPC B41J 29/377; B41J 2/04581; B41J 2/14209; B41J 2002/14362; B41J 2002/14491; B41J 2202/08

(57) ABSTRACT

A liquid droplet discharge head according to the present disclosure includes a head body, a driver IC, a flexible substrate, a heat dissipation plate, and a pressing member. The head body includes a plurality of discharge holes that discharge liquid droplets. The driver IC controls driving of the head body. the driver IC is mounted on the flexible substrate, and the flexible substrate is electrically connected to the head body. The heat dissipation plate dissipates heat generated by the driver IC. The pressing member presses the driver IC against the heat dissipation plate. The heat dissipation plate and the pressing member are fixed to each other at a center portion of the head body in the longitudinal direction thereof.

### CROSS-REFERENCE TO RELATED APPLICATIONS

This application is national stage application of International Application No. PCT/JP 2023/047355, filed on Dec. 28, 2023, which designates the United States, and which claims the benefit of priority from Japanese Patent Application No. 2022-212433, filed on Dec. 28, 2022.

### TECHNICAL FIELD

The present disclosure relates to a liquid droplet discharge head.

### BACKGROUND OF INVENTION

In related art, as a printing head, for example, a liquid discharge head is known that performs various types of printing by discharging a liquid onto a recording medium. Patent Document 1 discloses a liquid discharge head in which a driver IC is mounted on a flexible substrate.

### CITATION LIST

### Patent Literature

Patent Document 1: WO 2020/250873

### SUMMARY

In an aspect of the present disclosure, a liquid droplet discharge head includes a head body, a driver IC, a flexible substrate, a heat dissipation plate, and a pressing member. The head body includes a plurality of discharge holes that discharge liquid droplets. The driver IC controls driving of the head body. the driver IC is mounted on the flexible substrate, and the flexible substrate is electrically connected to the head body. The heat dissipation plate dissipates heat generated by the driver IC. The pressing member presses the driver IC against the heat dissipation plate. The heat dissipation plate and the pressing member are fixed to each other at a center portion of the head body in the longitudinal direction thereof.

### BRIEF DESCRIPTION OF THE DRAWINGS

FIG. 1 is a schematic side view of a printer according to a first embodiment.

FIG. 2 is a schematic plan view of the printer according to the first embodiment.

FIG. 3 is an exploded perspective view illustrating an overall configuration of a liquid droplet discharge head according to the first embodiment.

FIG. 4 is a perspective view for describing a structure of a flexible substrate according to the first embodiment and a structure of the vicinity of the flexible substrate.

FIG. 5 is a diagram for describing the entire configuration of the flexible substrate according to the first embodiment.

FIG. 6 is a diagram for describing a structure of a pressing member according to the first embodiment.

FIG. 7 is a schematic front view illustrating a configuration example of the liquid droplet discharge head.

FIG. 8 is a schematic front view illustrating the configuration example of the liquid droplet discharge head.

FIG. 9 is a schematic side view illustrating the configuration example of the liquid droplet discharge head.

FIG. 10 is a diagram illustrating a configuration of the flexible substrate according to a first variation of the first embodiment.

FIG. 11 is a schematic front view illustrating a configuration example of the liquid droplet discharge head according to a second variation of the first embodiment.

FIG. 12 is a schematic front view illustrating the configuration example of the liquid droplet discharge head according to the second variation of the first embodiment.

FIG. 13 is an exploded perspective view illustrating an overall configuration of a liquid droplet discharge head according to a second embodiment.

FIG. 14 is a schematic perspective view illustrating configurations of a wiring board, a first support member, and a second support member according to the second embodiment.

FIG. 15 is a perspective view illustrating a configuration of a pressing member according to the second embodiment.

FIG. 16 is a cross-sectional view taken along line XV-XV in FIG. 13.

FIG. 17 is a schematic cross-sectional view illustrating a configuration of one end portion of the liquid droplet discharge head according to a variation of the second embodiment.

### DESCRIPTION OF EMBODIMENTS

Modes (hereinafter will be referred to as “embodiments”) for implementing a liquid droplet discharge head according to the present disclosure will be described in detail below with reference to the accompanying drawings. Note that the present disclosure is not limited by the embodiments. Embodiments can be appropriately combined within a range so as not to contradict each other in terms of processing content. In the following embodiments, the same portions will be denoted by the same reference signs, and redundant descriptions will be omitted.

In the following embodiments, expressions such as “constant”, “orthogonal”, “perpendicular”, and “parallel” may be used, but these expressions need not necessarily mean exactly “constant”, “orthogonal”, “perpendicular”, and “parallel”. In other words, each of the expressions described above allows for deviations in, for example, manufacturing accuracy, or installation accuracy.

In related art, as a printing head, for example, a liquid discharge head is known that performs various types of printing by discharging a liquid onto a recording medium. Patent Document 1 discloses a liquid discharge head in which a driver IC is mounted on a flexible substrate. Patent Document 1 discloses a technique in which the driver IC is pressed against a heat dissipation plate by a pressing member, in order to bring the driver IC into close contact with the heat dissipation plate, thereby enhancing heat dissipation of the driver IC.

However, in the technique described in Patent Document 1, since the pressing member and the heat dissipation plate are fixed to each other only at both of end portions of a head body in the longitudinal direction thereof, the entire liquid discharge head has a structure in which a center portion of the liquid droplet discharge head in the longitudinal direction thereof, in particular, is weaker with respect to external pressure and/or internal pressure than both of end portions of the liquid droplet discharge head in the longitudinal direction thereof.

Thus, a technique for increasing the rigidity of the liquid droplet discharge head is anticipated.

### First Embodiment

### Configuration of Printer

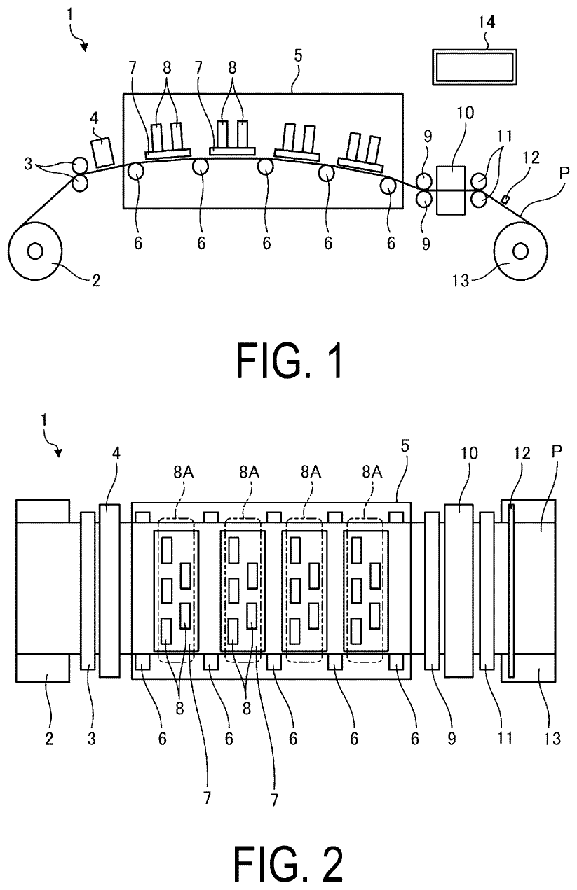

First, an outline of a printer 1, which is one example of a recording device according to a first embodiment, will be described with reference to FIGS. 1 and 2. FIG. 1 is a schematic side view of the printer 1 according to the first embodiment, and FIG. 2 is a schematic plan view of the printer 1. The printer 1 according to the first embodiment is, for example, a color inkjet printer.

As illustrated in FIG. 1, the printer 1 includes a paper feed roller 2, guide rollers 3, an applicator 4, a head case 5, a plurality of transport rollers 6, a plurality of frames 7, a plurality of liquid droplet discharge heads 8, transport rollers 9, a dryer 10, transport rollers 11, a sensor unit 12, and a collection roller 13.

The printer 1 further includes a controller 14 that controls the paper feed roller 2, the guide rollers 3, the applicator 4, the head case 5, the plurality of transport rollers 6, the plurality of frames 7, the plurality of liquid droplet discharge heads 8, the transport rollers 9, the dryer 10, the transport rollers 11, the sensor unit 12, and the collection roller 13.

The printer 1 records images or characters on printing paper P by causing liquid droplets to land on the printing paper P. The printing paper P is an example of a recording medium. The printing paper P is wound around the paper feed roller 2 before use. The printer 1 transports the printing paper P from the paper feed roller 2 to the inside of the head case 5 via the guide rollers 3 and the applicator 4.

The applicator 4 uniformly applies a coating agent to the printing paper P. In this way, surface treatment can be applied to the printing paper P, and thus the printing quality of the printer 1 can be improved.

The head case 5 accommodates the plurality of transport rollers 6, the plurality of frames 7, and the plurality of liquid droplet discharge heads 8. The inside of the head case 5 forms a space isolated from the outside except for a portion connected to the outside such as a portion where the printing paper P enters and leaves.

In the internal space of the head case 5, at least one of the controlling factors such as temperature, humidity, and air pressure is controlled by the controller 14 as required. The transport rollers 6 transport the printing paper P to the vicinity of the liquid droplet discharge heads 8 inside the head case 5.

The frames 7 are rectangular flat plates and positioned above and in close proximity to the printing paper P transported by the transport rollers 6. As illustrated in FIG. 2, the frame 7 is positioned such that the longitudinal direction thereof is orthogonal to a transport direction of the printing paper P. A plurality (e.g., four) of the frames 7 are positioned inside the head case 5 along the transport direction of the printing paper P.

Note that, in the following description, a direction in which the printing paper P is transported is also referred to as a “sub scanning direction,” and a direction orthogonal to the sub scanning direction and parallel to the printing paper P is also referred to as a “main scanning direction”.

A liquid, for example, ink, is supplied from a liquid tank (not illustrated) to the liquid droplet discharge head 8. The liquid droplet discharge head 8 discharges liquid droplets supplied from the liquid tank.

The controller 14 controls the liquid droplet discharge heads 8 based on data such as images and characters to discharge the liquid droplets toward the printing paper P. The distance between the liquid droplet discharge head 8 and the printing paper P is, for example, about 0.5 to 20 mm.

The liquid droplet discharge head 8 is fixed to the frame 7. For example, both of end portions of the liquid droplet discharge head 8 in the longitudinal direction thereof are fixed to the frame 7. The liquid droplet discharge head 8 is positioned such that the longitudinal direction thereof is orthogonal to the transport direction of the printing paper P.

That is, the printer 1 according to the first embodiment is a so-called line printer in which the liquid droplet discharge heads 8 are fixed inside the printer 1. Note that the printer 1 according to the first embodiment is not limited to the line printer, but may be a so-called serial printer.

The serial printer is a printer that employs a method of alternately performing an operation of recording while moving the liquid droplet discharge heads 8 so as to cause the liquid droplet discharge heads 8 to reciprocate in a direction intersecting (e.g., substantially orthogonal to) the transport direction of the printing paper P, and an operation of transporting the printing paper P.

As illustrated in FIG. 2, a plurality of (e.g., five) the liquid droplet discharge heads 8 are fixed in one frame 7. FIG. 2 illustrates an example in which three of the liquid droplet discharge heads 8 are positioned on the front side and two of the liquid droplet discharge heads 8 are positioned on the rear side in the transport direction of the printing paper P. The liquid droplet discharge heads 8 are positioned such that the centers thereof do not overlap each other in the transport direction of the printing paper P.

The plurality of liquid droplet discharge heads 8 positioned in one frame 7 constitute a head group 8A. Four of the head groups 8A are positioned along the transport direction of the printing paper P. The same color ink is supplied to the liquid droplet discharge heads 8 belonging to the same head group 8A. Thus, the printer 1 can perform printing with four colors of ink using the four head groups 8A.

The colors of the ink discharged from the respective head groups 8A are, for example, magenta (M), yellow (Y), cyan (C), and black (K). The controller 14 can print a color image on the printing paper P by controlling each of the head groups 8A and discharging inks of a plurality of colors onto the printing paper P.

Note that, in order to treat the surface of the printing paper P, the liquid droplet discharge heads 8 may discharge the coating agent onto the printing paper P.

The number of the liquid droplet discharge heads 8 included in one of the head groups 8A or the number of the head groups 8A mounted on the printer 1 can be changed as appropriate in accordance with a printing target or printing conditions. For example, when the color to be printed on the printing paper P is a single color and the printing range can be covered by one of the liquid droplet discharge heads 8, the number of liquid droplet discharge heads 8 mounted on the printer 1 may be one.

The printing paper P that has been printed inside the head case 5 is transported to the outside of the head case 5 by the transport rollers 9, and passes through the inside of the dryer 10. The dryer 10 dries the printing paper P that has been printed. The printing paper P dried by the dryer 10 is transported by the transport rollers 11 and collected by the collection roller 13.

In the printer 1, by drying the printing paper P using the dryer 10, sheets of the printing paper P that have been wound up in an overlapped manner can be suppressed from adhering to each other, and also, undried liquid on the printing paper P can be suppressed from rubbing onto the collection roller 13.

The sensor unit 12 is constituted by, for example, a position sensor, a speed sensor, or a temperature sensor. Based on information from the sensor unit 12, the controller 14 can determine the state of each unit of the printer 1 and control each unit of the printer 1.

In the printer 1 described above, a case has been described in which the printing paper P is used as the printing target (i.e., the recording medium). However, the printing target in the printer 1 is not limited to the printing paper P, and a rolled cloth or the like may be used as the printing target.

Instead of directly transporting the printing paper P itself, the printer 1 may transport the printing paper P placed on a transport belt. By using the transport belt, the printer 1 can use a sheet of paper, a cut cloth, wood, a tile, or the like as the printing target.

The printer 1 may print wiring patterns of an electronic device by discharging liquid droplets containing conductive particles from the liquid droplet discharge heads 8. The printer 1 may also discharge a predetermined amount of a liquid chemical agent or liquid droplets containing the chemical agent from the liquid droplet discharge heads 8 onto a reaction vessel or the like to produce chemicals.

The printer 1 may also include a cleaning unit that cleans the liquid droplet discharge heads 8. The cleaning unit cleans the liquid droplet discharge heads 8 by performing, for example, a wiping process or a capping process.

The wiping process is a process for removing a liquid adhering to the liquid droplet discharge head 8 by wiping the surface of a portion onto which the liquid droplets are discharged, for example, using a flexible wiper.

The capping process is performed, for example, as follows. First, a cap is placed over the surface of the portion onto which the liquid droplets are discharged (this is called capping). In this way, a substantially hermetically sealed space is created between the cap and the surface of the portion onto which the liquid droplets are discharged.

Subsequently, the discharge of the liquid droplets is repeated in the sealed space. As a result, a liquid having a viscosity higher than that of the liquid in a normal state, foreign matter or the like stuck in a discharge hole (a nozzle) for discharging the liquid droplets can be removed.

### Configuration of Liquid Droplet Discharge Head

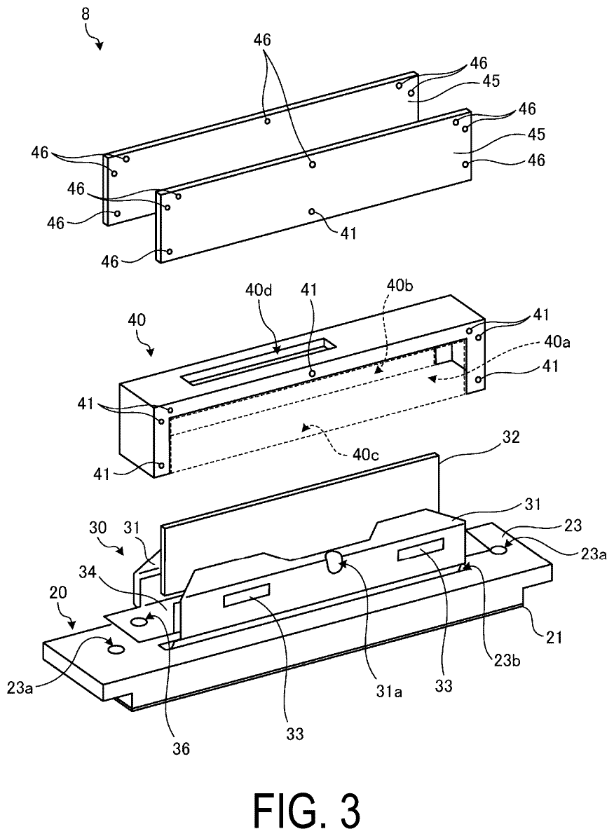

A configuration of the liquid droplet discharge head 8 according to the first embodiment will be described with reference to FIG. 3. FIG. 3 is an exploded perspective view illustrating an overall configuration of the liquid droplet discharge head 8 according to the first embodiment.

The liquid droplet discharge head 8 includes a head body 20, a wiring portion 30, a head cover 40, and two heat dissipation plates 45. The head body 20 includes a channel member 21, a piezoelectric actuator substrate (not illustrated), and a reservoir 23.

In the following description, for convenience, a direction in which the head body 20 is provided in the liquid droplet discharge head 8 may be referred to as “lower”, and a direction in which the head cover 40 is provided with respect to the head body 20 may be referred to as “upper”.

The channel member 21 of the head body 20 has a substantially flat plate shape and includes a first surface (not illustrated) which is one main surface, and a second surface (not illustrated) positioned on the opposite side to the first surface. The first surface includes an opening (not illustrated), and a liquid is supplied from the reservoir 23 to the inside of the channel member 21 through the opening.

A plurality of discharge holes (not illustrated) that discharge the liquid onto the printing paper P are positioned in the second surface. The channel member 21 internally includes a channel through which the liquid flows from the first surface to the second surface.

The piezoelectric actuator substrate is positioned on the first surface of the channel member 21. The piezoelectric actuator substrate includes a plurality of displacement elements (not illustrated). The piezoelectric actuator substrate is electrically connected to a flexible substrate 31 of the wiring portion 30.

The reservoir 23 is positioned on the piezoelectric actuator substrate. The reservoir 23 is provided with openings 23a at both of end portions of the reservoir 23 in the main scanning direction, which is a direction orthogonal to the sub scanning direction that is the transport direction of the printing paper P, and which is also a direction parallel to the printing paper P. In other words, the reservoir 23 includes two of the openings 23a. The reservoir 23 internally includes a channel, and the liquid is supplied to the reservoir 23 from the outside through the openings 23a. The reservoir 23 supplies the liquid to the channel member 21. The reservoir 23 also stores the liquid to be supplied to the channel member 21.

Note that, upon performing printing, the liquid may be supplied from one of the openings 23a and the other opening 23a may be closed. Alternatively, the liquid may be supplied from both of the openings 23a. When the liquid is first introduced into the liquid droplet discharge head 8, if the liquid is supplied from one of the openings 23a and recovered from the other opening 23a, air, a preservative solution, or the like in the channel inside the reservoir 23 easily escapes from the channel, and thus the introduction of the liquid into the liquid droplet discharge head 8 can be facilitated.

During the printing, the liquid may be supplied from one of the openings 23a and may be recovered from the other opening 23a. By doing so, air bubbles can be made less likely to accumulate in the channel inside the reservoir 23. In addition, by supplying a liquid adjusted to a constant temperature, the temperature of the liquid droplet discharge head 8 can be stabilized. The recovered liquid may be passed through a filter or the like before being supplied to the liquid droplet discharge head 8 once again. In other words, the liquid may be circulated. The controller 14 may control the supply and recovery of the liquid to and from the liquid droplet discharge head 8, or may control the circulation of the liquid.

In addition, the liquid may be supplied from the reservoir 23 to the channel member 21, and may be recovered from the channel member 21 to the reservoir 23. Alternatively, in the channel member 21, the liquid may be supplied to and recovered from the channel facing the nozzles (discharge holes) so that the liquid is less likely to stay in the nozzles and the periphery thereof. In such a mode, as a whole, the liquid is supplied to the liquid droplet discharge heads 8 from the outside, the liquid is partly discharged from the discharge holes, and the liquid that has not been discharged is recovered to the outside.

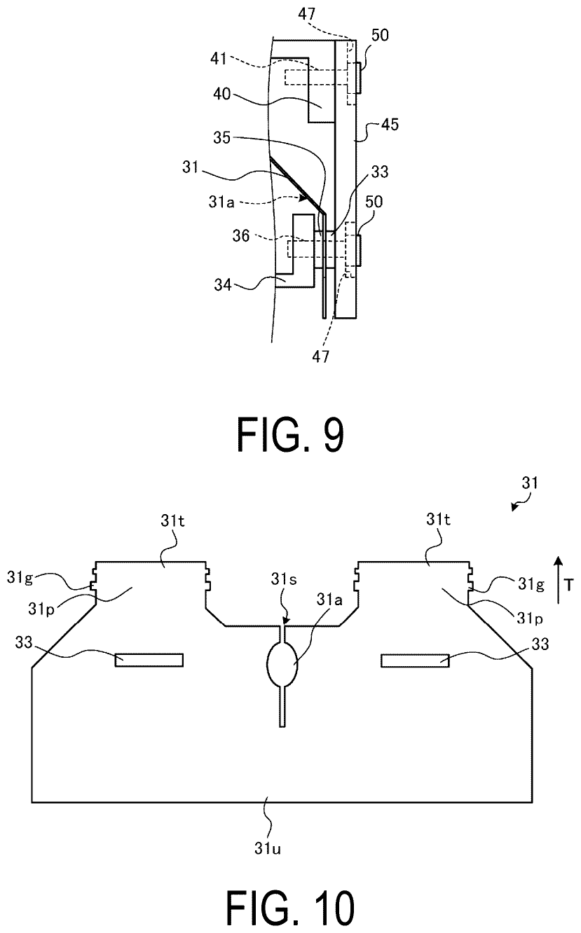

The wiring portion 30 includes the flexible substrate 31, a wiring board 32, a plurality of driver ICs 33, a pressing member 34, and an elastic member 35 (see FIG. 9). The flexible substrate 31 transmits, to the head body 20, a predetermined signal transmitted from the outside. Note that, as illustrated in FIG. 3, the liquid droplet discharge head 8 according to the first embodiment includes two of the flexible substrates 31.

The flexible substrate 31 includes one end portion electrically connected to the piezoelectric actuator substrate of the head body 20. The other end portion of the flexible substrate 31 is drawn out upward through a slit portion 23b of the reservoir 23, and is electrically connected to the wiring board 32. In this way, the piezoelectric actuator substrate of the head body 20 can be electrically connected to the outside. The flexible substrate 31 will be described in detail below.

The wiring board 32 is positioned above the head body 20. The wiring board 32 distributes signals to the plurality of driver ICs 33.

The plurality of driver ICs 33 are provided on one main surface of the flexible substrate 31. As illustrated in FIG. 3, in the liquid droplet discharge head 8 according to the first embodiment, two of the driver ICs 33 are provided on one flexible substrate 31. Note that the number of driver ICs 33 provided on one flexible substrate 31 is not limited to two.

The driver IC 33 drives the piezoelectric actuator substrate of the head body 20 based on a drive signal transmitted from the controller 14 (see FIG. 1). In this way, the driver IC 33 drives the liquid droplet discharge head 8.

The pressing member 34 is, for example, a plate spring having a substantially U shape in a cross-sectional view. The pressing member 34 is positioned between two of the flexible substrates 31 drawn out from the slit portions 23b, and presses the driver ICs 33 on the flexible substrate 31 toward the heat dissipation plate 45. In this way, the driver ICs are brought into close contact with the heat dissipation plates 45, and heat generated when the driver ICs 33 are driven can be efficiently dissipated to the heat dissipation plates 45. The pressing member 34 will be described in detail below.

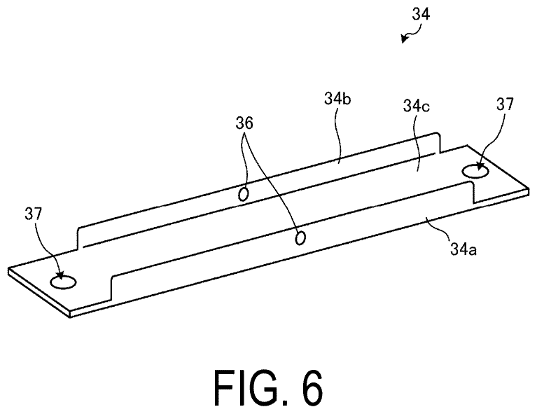

The elastic members 35 (see FIG. 9) are in contact with sidewall portions 34a and 34b (see FIG. 6) of the pressing member 34. By providing the elastic members 35, when the pressing member 34 presses the driver ICs 33, the likelihood of the pressing member 34 damaging the flexible substrate 31 can be reduced.

The elastic member 35 is made of, for example, a double-sided foam tape or the like. For example, by using a non-silicon-based thermal conductive sheet as the elastic member 35, heat dissipation of the driver IC 33 can be improved. Note that the elastic member 35 need not necessarily be provided.

The head cover 40 is attached to the head body 20 and covers the wiring portion 30 positioned on the head body 20 such as the flexible substrates 31 drawn out from the slit portions 23b, the wiring board 32, the pressing member 34, and the like. In this way, the head cover 40 can seal the wiring portion 30. The head cover 40 is made of, for example, a resin or a metal.

The head cover 40 has a box shape extending long in the main scanning direction and includes a first opening 40a and a second opening 40b at two side surfaces facing each other along the sub scanning direction, respectively. The head cover 40 also includes a third opening 40c at the lower surface thereof, and a fourth opening 40d at the upper surface thereof.

The two heat dissipation plates 45 are attached to the head cover 40. One of the two heat dissipation plates 45 is disposed so as to close the first opening 40a, and the other heat dissipation plate 45 is disposed so as to close the second opening 40b.

The heat dissipation plate 45 is, for example, a plate-like member that is long in the main scanning direction and is made of a metal, an alloy, or the like having high heat dissipating properties. The heat dissipation plate 45 is in contact with the driver ICs 33 and has a function of dissipating the heat generated by the driver ICs 33.

Each of the two heat dissipation plates 45 includes a plurality of through holes 46 that accommodate fixing members 50 (see FIG. 8). The two heat dissipation plates 45 are each fixed to the head cover 40 with the fixing members 50 (see FIG. 8). The head cover 40 to which the heat dissipation plates 45 are attached has a box shape in which the first opening 40a and the second opening 40b are closed and the third opening 40c and the fourth opening 40d are open.

The third opening 40c is positioned so as to face the reservoir 23. The flexible substrates 31 and the pressing member 34 are inserted into the third opening 40c.

The fourth opening 40d is provided so that a connector (not illustrated) provided at the wiring board 32 can be inserted into the fourth opening 40d. When a space between the connector and the fourth opening 40d is sealed with a resin or the like, liquid, dust, or the like is less likely to enter the head cover 40.

The head cover 40 may also include thermal insulating portions (not illustrated) between the heat dissipation plates 45 and the head body 20. By providing the thermal insulating portions at the head cover 40, heat generated by the driver ICs 33 is less likely to be transferred to the head body 20 via the heat dissipation plates 45.

Note that FIG. 3 illustrates an example of the configuration of the liquid droplet discharge head 8, and the liquid droplet discharge head 8 may further include a member other than the members illustrated in FIG. 3.

### Details of Flexible Substrate

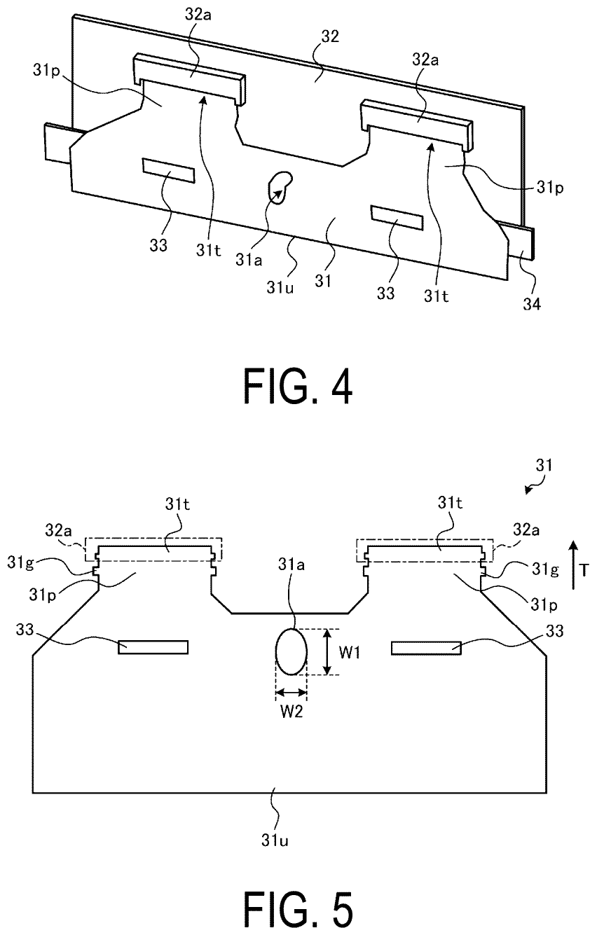

Details of the flexible substrate 31 according to the first embodiment will be described with reference to FIGS. 4 and 5. FIG. 4 is a perspective view for describing a structure of the flexible substrate 31 according to the first embodiment and a structure of the vicinity of the flexible substrate 31. Note that, in FIG. 4, various elements and the like on the wiring board 32 are omitted.

The flexible substrate 31 has a bifurcated shape in which each of two bifurcated portions is gradually tapered toward the upper direction. In other words, the flexible substrate 31 includes two protruding portions 31p each protruding in the upper direction. A lower portion 31u of the flexible substrate 31 is electrically connected to the head body 20 (see FIG. 3).

A front end portion of the protruding portion 31p of the flexible substrate 31 is inserted, as a connector insertion portion 31t, into a connector 32a provided at the wiring board 32. By inserting the connector insertion portion 31t into the connector 32a, the flexible substrate 31 and the wiring board 32 can be electrically connected to each other.

Each of the plurality of driver ICs 33 is mounted below each of a plurality of the connector insertion portions 31t of the flexible substrate 31. The pressing member 34 is provided at a side of the flexible substrate 31 opposite from a side at which the driver ICs 33 are mounted. The pressing member 34 presses the driver ICs 33 from the inner side toward the heat dissipation plates 45 (see FIG. 3). Note that the positions at which the driver ICs 33 are mounted are not limited to the positions below the connector insertion portions 31t.

The flexible substrate 31 includes a through hole 31a between two adjacent ones of the driver ICs 33. The through hole 31a will be described in detail below.

FIG. 5 is a diagram for describing the entire configuration of the flexible substrate 31 according to the first embodiment. Note that, in FIG. 5, the positions of the corresponding connectors 32a are illustrated with the long dash-dotted lines.

As illustrated in FIG. 5, the flexible substrate 31 includes a plurality of the protruding portions 31p (two in FIG. 5) protruding in the same direction. The protruding portions 31p protrude in an inserting direction T of the connector insertion portions 31t.

Since the flexible substrate 31 has flexibility and the width of the protruding portion 31p is reduced, the flexible substrate 31 has a shape in which the connector insertion portions 31t are easily inserted into the connectors 32a at the time of insertion.

In the first embodiment, the through hole 31a is formed between two adjacent ones of the driver ICs 33 in the flexible substrate 31. For example, the through hole 31a is formed at the center between the two adjacent driver ICs 33, so as to extend across the space between the two adjacent driver ICs 33. The fixing member 50 (FIG. 8) that fixes the pressing member 34 and the heat dissipation plate 45 is inserted into the through hole 31a. This point will be described later.

In this way, a heat transfer path from one of the driver ICs 33 to the other driver IC 33 in the flexible substrate 31 can be extended. Thus, according to the first embodiment, thermal interference between the adjacent driver ICs 33 can be reduced.

In the first embodiment, the through hole 31a is closed in the plane of the flexible substrate 31. In other words, an edge portion of the through hole 31a does not reach any of the sides constituting the flexible substrate 31. In this way, the yield of the flexible substrate 31 can be increased compared to a case where the flexible substrate 31 has a slit 31s (see FIG. 10) as in a variation described later.

In the first embodiment, a width W1 of the through hole 31a in a direction (up-down direction) orthogonal to the longitudinal direction of the head body 20 is larger than a width W2 of the through hole 31a in the longitudinal direction (left-right direction). In this way, since play can be created in the direction orthogonal to the longitudinal direction, when the flexible substrate 31 deforms, the deformation is easily handled.

Note that a shank 31g protruding in the width direction of the protruding portion 31p may be provided at a side portion of the protruding portion 31p adjacent to the connector insertion portion 31t. In the example illustrated in FIG. 5, two of the shanks 31g are provided at one side portion.

In the first embodiment, by inserting the connector insertion portions 31t into the connectors 32a while holding the shanks 31g, the connector insertion portions 31t can be more easily inserted into the connectors 32a.

### Details of Pressing Member

The pressing member 34 according to the first embodiment will be described in detail with reference to FIG. 6. FIG. 6 is a diagram for describing a structure of the pressing member 34 according to the first embodiment.

The pressing member 34 includes the two sidewall portions 34a and 34b and a lower surface portion 34c. The sidewall portions 34a and 34b face the flexible substrates 31 drawn out from the slit 31s. Each of the two sidewall portions 34a and 34b includes a through hole 36. The fixing member 50 (see FIG. 8) that fixes the pressing member 34 and the heat dissipation plate 45 is inserted into the through hole 36. The lower surface portion 34c connects the lower ends of the two sidewall portions 34a and 34b. The lower surface portion 34c includes through holes 37 at both of end portions of the head body 20 in the longitudinal direction thereof. A channel member (not illustrated) is connected to the through hole 37.

The liquid droplet discharge head 8 has a structure in which a center portion of the head body 20 in the longitudinal direction thereof is weaker with respect to external pressure and/or internal pressure than both the end portions of the head body 20 in the longitudinal direction thereof, for reasons such as fewer components for fastening a plurality of members.

Therefore, the heat dissipation plates 45 and the pressing member 34 of the liquid droplet discharge head 8 according to the first embodiment are fixed to each other at the center portion of the head body 20 in the longitudinal direction thereof.

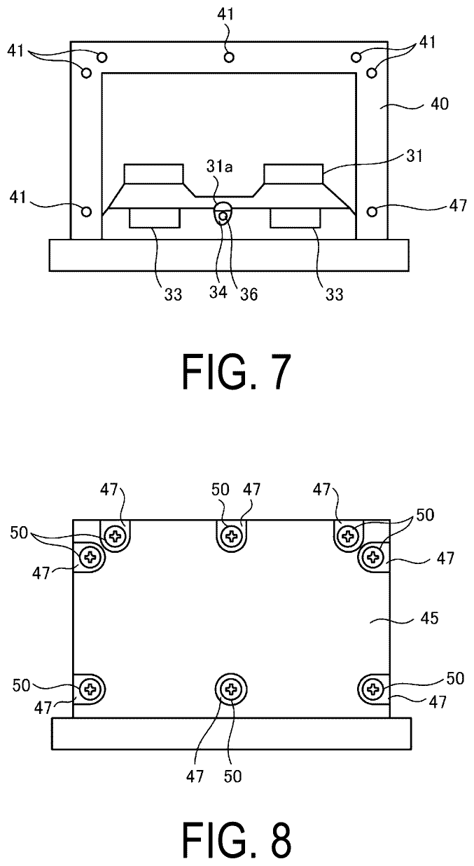

Hereinafter, details of fixing locations between the heat dissipation plate 45 and the pressing member 34 will be described with reference to FIGS. 7 to 9. FIGS. 7 and 8 are schematic front views each illustrating a configuration example of the liquid droplet discharge head 8. FIG. 9 is a schematic side view illustrating the configuration example of the liquid droplet discharge head 8. Note that, in FIG. 7, the heat dissipation plate 45 and the fixing members 50 are omitted for ease of understanding. FIG. 9 illustrates a side surface of the liquid droplet discharge head 8 in the vicinity of a center portion of the liquid droplet discharge head 8 in the longitudinal direction thereof.

Note that, in the first embodiment, both the end portions of the liquid droplet discharge head 8 in the longitudinal direction thereof (head body 20) refers to portions in a range from 0% to 20% from both ends of the liquid droplet discharge head 8 (head body 20), and the center portion of the liquid droplet discharge head 8 (head body 20) refers to a portion other than both the end portions of the liquid droplet discharge head 8 (head body 20).

In the first embodiment, the heat dissipation plate 45 and the pressing member 34 are fixed to each other at the center portion of the head body 20 in the longitudinal direction thereof. In this way, sealing properties of the liquid droplet discharge head 8 can be improved. Specifically, the heat dissipation plate 45 and the head cover 40 are fixed to each other by the fixing members 50 at the center portion and both the end portions of the head body 20 in the longitudinal direction thereof. In this way, floating of the head cover 40 can be suppressed, and also the sealing properties of the liquid droplet discharge head 8 can be improved.

The fixing member 50 includes a head. As the fixing member 50, for example, a screw or a bolt may be used.

As illustrated in FIG. 9, in the first embodiment, the heat dissipation plate 45 and the pressing member 34 are fixed to each other via the through hole 31a of the flexible substrate 31.

In this way, the flexible substrate 31 can also be fixed together with the heat dissipation plate 45 and the pressing member 34.

In the first embodiment, the heat dissipation plate 45 and the pressing member 34 are fixed to each other by the fixing member 50 between two adjacent ones of the driver ICs 33. In this way, heat can be dissipated to the heat dissipation plate 45 via the fixing members 50, and the thermal interference between the two adjacent driver ICs 33 can be reduced.

In the first embodiment, the heat dissipation plate 45 has a plurality of recesses 47 that accommodate the heads of the fixing members 50. In this way, compared to a case where the recesses 47 are not provided, the amount of protrusion of the fixing member 50 can be reduced, and the liquid droplet discharge head 8 can be downsized in the lateral direction.

### First Variation of First Embodiment

A variation of the flexible substrate 31 according to the first embodiment will be described with reference to FIG. 10. FIG. 10 is a diagram illustrating a configuration of the flexible substrate 31 according to a first variation of the first embodiment. Note that, in the variation below, redundant explanations will be omitted with the same parts as those in the first embodiment denoted with the same reference signs.

As illustrated in FIG. 10, in the flexible substrate 31 according to the first variation of the first embodiment, the slit 31s is formed between two adjacent ones of the driver ICs 33. The slit 31s is formed so as to extend from a side (the upper side in FIG. 10) from which the protruding portions 31p protrude in the flexible substrate 31 in a direction (the downward direction in FIG. 10) opposite to the direction in which the protruding portions 31p protrude. One end of the slit 31s is connected to the through hole 31a.

In this way, when inserting the connector insertion portions 31t into the connectors 32a, not only the protruding portions 31p but also the vicinity of the slit 31s can easily deform. Thus, the flexible substrate 31 according to the first embodiment has a shape in which the connector insertion portions 31t are easily inserted into the connectors 32a at the time of insertion. Therefore, compared to a case where the slit 31s is not provided, the flexible substrate 31 can be easily moved freely, and workability can be improved.

In the first variation of the first embodiment, the slit 31s may be formed at the center between the protruding portions 31p adjacent to each other. If the slit 31s is formed at an off-center position between the adjacent protruding portions 31p, the protruding portion 31p disposed closer to the slit 31s can easily deform up to the vicinity of the slit 31s, whereas the protruding portion 31p disposed further away from the slit 31s is less likely to deform up to the vicinity of the slit 31s.

However, in the first variation of the first embodiment, the slit 31s is formed at the center between the adjacent protruding portions 31p. Thus, both of the protruding portions 31p can be caused to evenly deform to the vicinity of the slit 31s. Therefore, according to the first variation of the first embodiment, the connector insertion portions 31t can be easily evenly inserted.

### Second Variation of First Embodiment

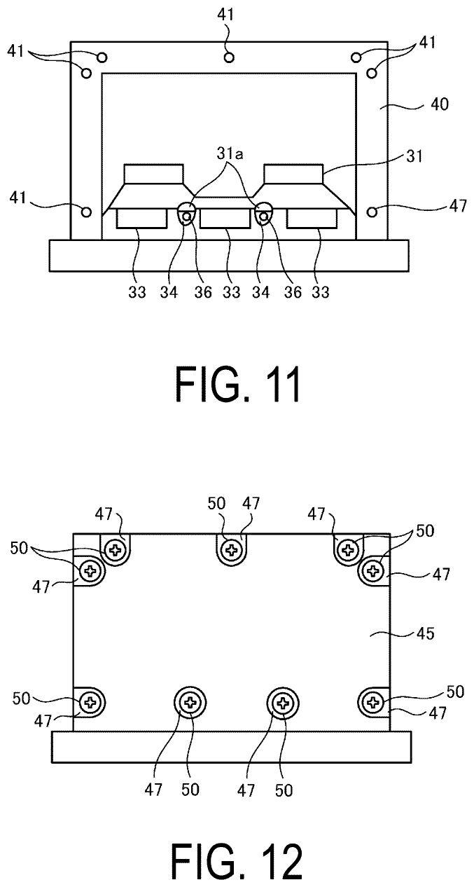

A variation of the liquid droplet discharge head 8 according to the first embodiment will be described with reference to FIGS. 11 and 12. FIGS. 11 and 12 are schematic front views each illustrating a configuration example of the liquid droplet discharge head 8 according to a second variation of the first embodiment. Note that, in FIG. 11, the heat dissipation plate 45 and the fixing members 50 are omitted for ease of understanding.

The heat dissipation plate 45 and the pressing member 34 may be fixed to each other at a plurality of locations in the center portion of the head body 20 in the longitudinal direction thereof. For example, as illustrated in FIGS. 11 and 12, the flexible substrate 31 may include three of the driver ICs 33. One of the three driver ICs 33 is positioned at the center in the longitudinal direction of the head body 20. In such a case, the pressing member 34 may include two of the through holes 36 in a center portion in the longitudinal direction thereof.

In a side view (FIG. 11) in which the flexible substrate 31 is viewed from the lateral direction of the head body 20, the two through holes 36 are provided at positions so that the driver IC 33 positioned at the center in the longitudinal direction of the head body 20 is sandwiched between the two through holes 36. In other words, each of the through holes 36 are positioned between two adjacent ones of the driver ICs 33.

The heat dissipation plate 45 includes two of the through holes 46 in the center portion in the longitudinal direction thereof. The fixing members 50 fix the pressing member 34 and the heat dissipation plate 45 via the through holes 31a. In this way, the heat dissipation plate 45 and the pressing member 34 may be fixed to each other at the plurality of locations in the center portions in the longitudinal direction thereof. As a result, the sealing properties of the liquid droplet discharge head 8 can be improved.

Note that the configuration is not limited to the example illustrated in FIG. 11, and the second variation described above may be applied to a case where two of the driver ICs 33 are mounted on the flexible substrate 31, for example. When two of the driver ICs 33 are mounted on the flexible substrate 31, by providing a plurality of the through holes 31a between the two driver ICs 33 adjacent to each other, the pressing member 34 and the heat dissipation plate 45 can be fixed to each other through the through holes 31a. Note that the configuration is not limited to the example illustrated in FIG. 11, and the second variation described above may be applied to a case where four or more of the driver ICs 33 are provided.

### Second Embodiment

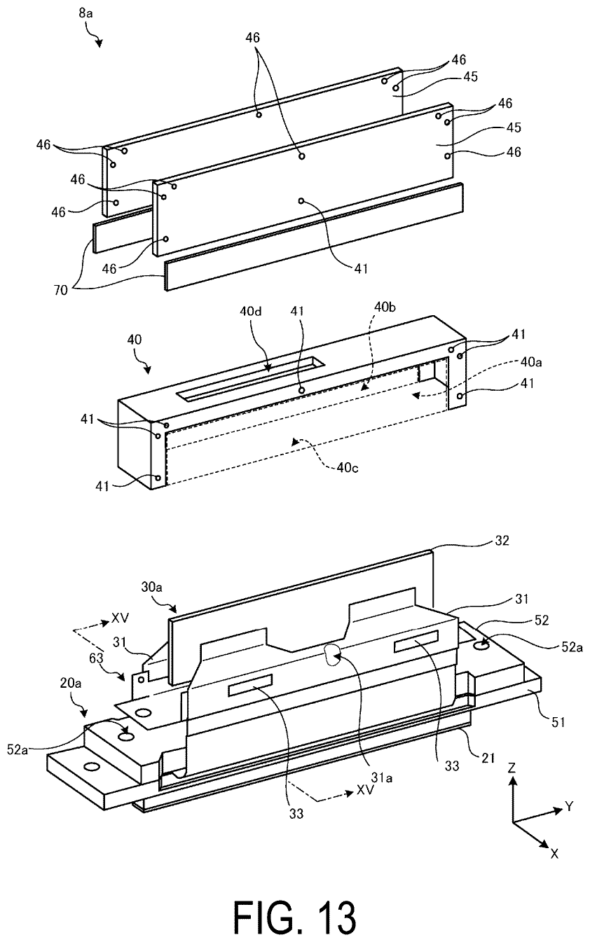

A liquid droplet discharge head 8a according to a second embodiment will be described with reference to FIGS. 13 to 16. FIG. 13 is an exploded perspective view illustrating an overall configuration of the liquid droplet discharge head 8a according to the second embodiment.

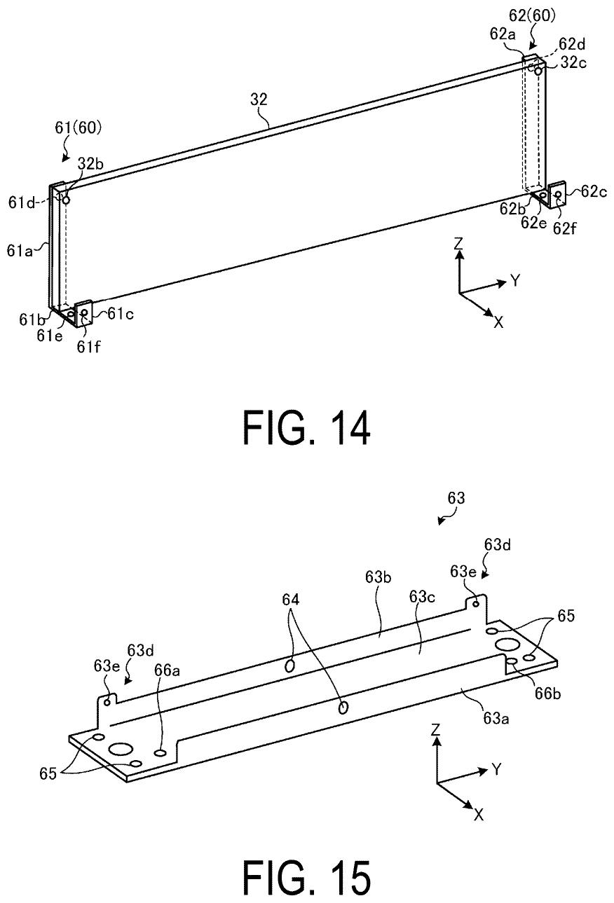

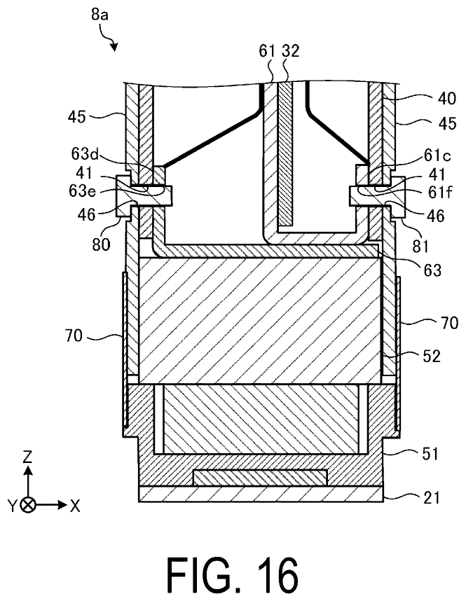

FIG. 14 is a schematic perspective view illustrating configurations of the wiring board 32, a first support member 61, and a second support member 62 according to the second embodiment. FIG. 15 is a schematic perspective view illustrating a configuration of a pressing member 63 according to the second embodiment. FIG. 16 is a cross-sectional view taken along line XV-XV in FIG. 13. In other words, FIG. 16 is a cross-sectional view of one of the end portions in the longitudinal direction of the head body 20. Note that, in FIG. 13, support members 60 are omitted for ease of understanding. In the second embodiment below, redundant explanations will be omitted with the same parts as those in the first embodiment denoted with the same reference signs.

The liquid droplet discharge head 8 illustrated in FIG. 13 is different from the liquid droplet discharge head 8 according to the first embodiment illustrated in FIG. 3 mainly in the configurations of the head body 20 and the wiring portion 30.

Similarly to the liquid droplet discharge head 8 according to the first embodiment illustrated in FIG. 3, the liquid droplet discharge head 8a according to the second embodiment includes a head body 20a, a wiring portion 30a, the head cover 40, and two of the heat dissipation plates 45.

The head body 20a includes the channel member 21, a piezoelectric actuator substrate (not illustrated), a branched channel member 51, and a reservoir 52.

The branched channel member 51, which is a connection channel member, is positioned on the channel member 21. The branched channel member 51 internally includes a branched channel (not illustrated) which is a connection channel connected to the channel of the channel member 21. The branched channel member 51 is made of a high-rigidity material such as stainless steel.

Note that the branched channel member 51 may be a member having a box shape extending long in the main scanning direction (Y-axis direction) and having an open upper surface. Since the branched channel member 51 has the box shape, the rigidity of the branched channel member 51 can be increased compared to a case where the branched channel member 51 has a flat plate shape. As a result, the deflection amount of a nozzle surface of the channel member 21 joined to the branched channel member 51 can be reduced.

The reservoir 52 is positioned on the branched channel member 51. The reservoir 52 includes openings 52a at both of end portions thereof in the main scanning direction (Y-axis direction). The reservoir 52 internally includes a channel and is supplied with a liquid from the outside through the openings 52a. The reservoir 52 supplies the liquid to the branched channel member 51. The reservoir 52 also stores the liquid to be supplied to the branched channel member 51.

The wiring portion 30a includes the flexible substrates 31, the wiring board 32, a plurality of the support members 60, a plurality of the driver ICs 33, the pressing member 63, and the elastic member 35 (see FIG. 9).

As illustrated in FIG. 14, the plurality of support members 60 support the wiring board 32. Specifically, the plurality of support members 60 include the first support member 61 and the second support member 62.

The first support member 61 is positioned at one end portion of the wiring board 32 in the longitudinal direction of the head body 20a. Specifically, the first support member 61 includes a base portion 61b, a support portion 61a extending perpendicularly from one end in the longitudinal direction of the base portion 61b, and an anchor 61c extending perpendicularly from the other end in the longitudinal direction of the base portion 61b. The wiring board 32 is positioned such that the bottom surface thereof is positioned on the base portion 61b and one main surface thereof is in contact with the support portion 61a.

A through hole 61d is formed in the support portion 61a. The wiring board 32 includes a through hole 32b penetrating both the main surfaces of the wiring board 32, at a position corresponding to the through hole 61b. A fixing member (not illustrated) such as a bolt or a screw is inserted and screwed into the through hole 61d and the through hole 32b to fix the wiring board 32 and the first support member 61. A through hole 61e is formed in the base portion 61b. The anchor 61c will be described in detail below.

The second support member 62 is positioned at the other end portion of the wiring board 32 in the longitudinal direction of the head body 20a. Specifically, the second support member 62 includes a base portion 62b, a support portion 62a extending perpendicularly from one end in the longitudinal direction of the base portion 62b, and an anchor 62c extending perpendicularly from the other end in the longitudinal direction of the base portion 62b. The wiring board 32 is positioned such that the bottom surface thereof is positioned on the base portion 62b and one main surface thereof is in contact with the support portion 62a.

A through hole 62d is formed in the support portion 62a. The wiring board 32 includes a through hole 32b penetrating both the main surfaces of the wiring board 32, at a position corresponding to the through hole 61b. A fixing member (not illustrated) such as a bolt or a screw is inserted and screwed into the through hole 61d and the through hole 32b to fix the wiring board 32 and the second support member 62. A through hole 62e is formed in the base portion 62b. The anchor 62c will be described in detail below.

As illustrated in FIG. 15, the pressing member 63 includes two sidewall portions 63a and 63b, a bottom portion 63c, and two anchors 63d.

Each of the two sidewall portions 63a and 63b includes a through hole 64 in a center portion in the longitudinal direction thereof. The fixing member 50 (see FIG. 8) that fixes the pressing member 63 and the heat dissipation plate 45 is inserted into the through hole 64.

The bottom portion 63c connects the lower ends of the two sidewall portions 63a and 63b. The bottom portion 63c includes a plurality of through holes 65 at both the end portions in the longitudinal direction of the head body 20. In the reservoir 52, through holes (not illustrated) are positioned at positions corresponding to the through holes 65. In the branched channel member 51, screw holes (not illustrated) are positioned at the positions corresponding to the through holes 65. Fixing members (not illustrated) such as bolts or screws are inserted into the through holes 65 formed in the bottom portion 63c of the pressing member 63 and the through holes of the reservoir 52. The fixing members (not illustrated) are screwed into the screw holes of the branched channel member 51. In this way, the pressing member 63 is fixed to the branched channel member 51, which is made of the high-rigidity material, via the reservoir 52.

In the bottom portion 63c, a through hole 66a is formed at a position corresponding to the through hole 61e (see FIG. 14) in the base portion 61b of the first support member 61. A fixing member (not illustrated) such as a bolt or a screw is inserted into the through hole 66a and the through hole 61e. The fixing member (not illustrated) is screwed into, for example, a screw groove formed in the through hole 61e. As a result, the first support member 61 is fixed to the pressing member 63. In the bottom portion 63c, a through hole 66b is formed at a position corresponding to the through hole 62e in the base portion 62b of the second support member 62. A fixing member (not illustrated) such as a bolt or a screw is inserted into the through hole 66b and the through hole 62e. The fixing member (not illustrated) is screwed into, for example, a screw groove formed in the through hole 62e. As a result, the second support member 62 is fixed to the pressing member 63. By being fixed to the pressing member 63 in this way, the first support member 61 is fixed to the branched channel member 51, which is made of the high-rigidity material, via the pressing member 63 and the reservoir 52.

The two anchors 63d are provided at both of end portions of one of the two sidewall portions 63a and 63b (here, the sidewall portion 63b). In other words, the two anchors 63d are provided at both of end portions of the pressing member 63 in the longitudinal direction of the head body 20. The anchor 63d will be described in detail below.

As described above, the pressing member 63 and the plurality of support members 60 according to the second embodiment are fixed to the branched channel member 51 made of the high-rigidity material. The heat dissipation plate 45 according to the second embodiment is fixed to the pressing member 63 and the plurality of support members 60 at both the end portions in the longitudinal direction of the head body 20. In the liquid droplet discharge head 8a having such a configuration, even when an external force is applied to the heat dissipation plate 45, the head cover 40 is unlikely to fall over.

Hereinafter, fixing locations between the head cover 40, and the pressing member 63 and the plurality of support members 60 will be described in detail with reference to FIG. 16. FIG. 16 illustrates a configuration of fixing locations at one end portion in the longitudinal direction of the liquid droplet discharge head 8a. Although a configuration of fixing locations at the other end portion is omitted. the fixing locations at the other end portion have the same configuration as that of the fixing locations at the one end portion.

First, a fixing location at one end side in the width direction of the liquid droplet discharge head 8a, that is, on the negative X-axis direction side will be described. The through hole 63e is formed in the anchor 63d of the pressing member 63. In the head cover 40, a through hole 41 is positioned at a position corresponding to the through hole 63e. In one of the two heat dissipation plates 45, a through hole 46 is positioned at a position corresponding to the through hole 63e. A fixing member 80 is inserted into and screwed into the through hole 63e, the through hole 41, and the through hole 46. As a result, the pressing member 63, the head cover 40, and the heat dissipation plate 45 are fixed to one end portion in the longitudinal direction of the head body 20.

A fixing location on the other end side in the width direction of the liquid droplet discharge head 8a, that is, on the positive X-axis direction side will be described. A through hole 61f is formed in the anchor 61c of the first support member 61. In the head cover 40, the through hole 41 is located at a position corresponding to the through hole 61f. In the other one of the two heat dissipation plates 45, the through hole 46 is positioned at a position corresponding to the through hole 61f. The fixing member 80 is inserted and screwed into the through hole 61f, the through hole 41, and the through hole 46. As a result, the first support member 61, the head cover 40, and the heat dissipation plate 45 are fixed to the one end portion of the head body 20 in the longitudinal direction thereof.

In the other end portion of the head body 20 in the longitudinal direction thereof, the pressing member 63 or the second support member 62, the head cover 40, and the heat dissipation plates 45 are fixed by the fixing members. In this way, the heat dissipation plates 45 and the head cover 40 according to the second embodiment are fixed to members that are directly or indirectly fixed to the branched channel member 51 (here, the pressing member 63, the first support member 61, and the second support member 62) at both the end portions of the head body 20 in the longitudinal direction thereof. In this way, even when an external force is applied to the liquid droplet discharge head 8a, the head cover 40 can be made less likely to fall over. If the head cover 40 falls over, resin sealing between the head cover 40 and the reservoir 52 may be peeled off. In contrast, in the liquid droplet discharge head 8a according to the second embodiment, the head cover 40 is less likely to fall over and thus the sealing is less likely to be broken.

In the liquid droplet discharge head 8a according to the second embodiment, similarly to the liquid droplet discharge head 8 according to the first embodiment, the heat dissipation plates 45 and the pressing member 63 may be fixed to each other at the center portion of the head body 20 in the longitudinal direction thereof. In this way, sealing properties of the liquid droplet discharge head 8a can be improved.

The liquid droplet discharge head 8a according to the second embodiment may further include two sheet members 70 that join the heat dissipation plate 45 and the head body 20.

The sheet member 70 is made of a resin and joins the heat dissipation plate 45 and the head body 20. The sheet member 70 is a member extending long in the main scanning direction (Y-axis direction). The width of the sheet member 70 in the longitudinal direction thereof is substantially the same as the width of the heat dissipation plate 45 in the longitudinal direction thereof. The thermal conductivity of the sheet member 70 may be lower than the thermal conductivity of the heat dissipation plate 45. By providing the sheet members 70, heat generated by the driver ICs 33 is less likely to be transferred to the head body 20 via the heat dissipation plates 45.

The sheet member 70 may be bonded to the heat dissipation plate 45 and the head body 20 by a double-sided tape, an adhesive, or the like.

As described above, the liquid droplet discharge head 8a according to the second embodiment is fixed at both of end portions, in the longitudinal direction, of the members directly or indirectly fixed to the branched channel member 51, the heat dissipation plates 45, and the head body 20. In this way, the rigidity of the liquid droplet discharge head 8a can be increased.

Note that, here, an example has been described in which the members fixed to the heat dissipation plates 45 at both the end portions of the head body 20 in the longitudinal direction thereof are the pressing member 63 and the support members 60. However, those members may be any member directly or indirectly fixed to at least the branched channel member 51, and need not necessarily be the pressing member 63 and the support members 60. For example, the member fixed to the heat dissipation plate 45 at both the end portions of the head body 20 in the longitudinal direction thereof may be only the pressing member 63. In this case, the anchors 63d may be provided at both the two sidewall portions 63a and 63b (see FIG. 15) of the pressing member 63, respectively. The member fixed to the heat dissipation plate 45 at both the end portions of the head body 20 in the longitudinal direction thereof may be only the support members 60, or may be another member.

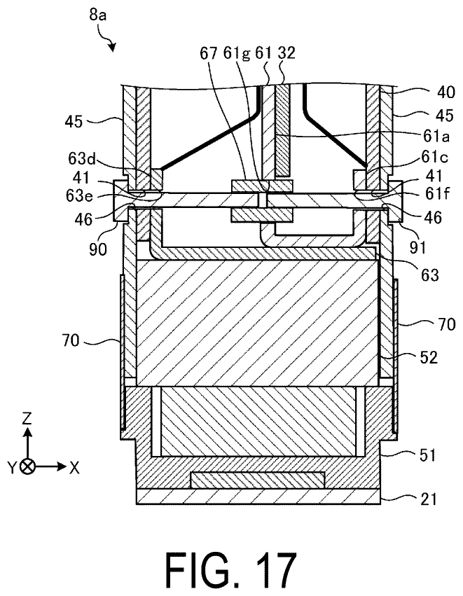

Variation of Second Embodiment A variation of the liquid droplet discharge head 8a according to the second embodiment will be described with reference to FIG. 17. FIG. 17 is a schematic cross-sectional view illustrating a configuration of one end portion of the liquid droplet discharge head 8a according to the variation of the second embodiment. Note that, in the variation below, redundant explanations are omitted with the same parts as those in the second embodiment denoted by the same reference signs.

The fixing member for fixing the heat dissipation plate 45 to the pressing member 63 and the fixing member for fixing the heat dissipation plate 45 to the support member 60 may be fastened to the same member.

Specifically, as illustrated in FIG. 17, the first support member 61 may have a tube 67 in which a screw groove is formed in the inner peripheral surface thereof. The tube 67 has, for example, a cylindrical shape. For example, the tube 67 may be inserted through a notch 61g provided in the support portion 61a of the first support member 61. Alternatively, the tube 67 may be formed integrally with the first support member 61. A first male screw 90 is inserted into the through hole 46 of one of the two heat dissipation plates 45, the through hole 41 of the head cover 40, and the through hole 63e of the anchor 63d of the pressing member 63. The first male screw 90 is screwed into the tube 67. In this way, the one of the two heat dissipation plates 45, the head cover 40, and the pressing member 63 are fixed at one end portion of the head body 20 in the longitudinal direction thereof.

A second male screw 91 is inserted into the through hole 46 of the other one of the two heat dissipation plates 45, the through hole 41 of the head cover 40, and the through hole 61e of the anchor 61c of the first support member 61. The second male screw 91 is screwed into the tube 67. In this way, the other one of the two heat dissipation plates 45, the head cover 40, and the first support member 61 are fixed at the one end portion of the head body 20 in the longitudinal direction thereof.

At the other end portion of the head body 20 in the longitudinal direction thereof, the second support member 62 may also include a tube (not illustrated) having a screw groove formed in the inner peripheral surface thereof, and a first male screw (not illustrated) that fixes the one of the two heat dissipation plates 45 to the pressing member 63, and a second male screw (not illustrated) that fixes the other one of the two heat dissipation plates 45 to the second support member 62 may be fastened to the same tube.

As described above, in the liquid droplet discharge head 8a according to the second embodiment, the first male screw 90 and the second male screw 91 are fastened to the same tube 67, and thus the rigidity of the liquid droplet discharge head 8a can be further increased.
In an embodiment, (1) a liquid droplet discharge head (e.g., the liquid droplet discharge head 8) includes a head body (e.g., the head body 20), a driver IC (e.g., the driver IC 33), a flexible substrate (e.g., the flexible substrate 31), a heat dissipation plate (e.g., the heat dissipation plate 45), and a pressing member (e.g., the pressing member 34). The head body includes a plurality of discharge holes that discharge liquid droplets. The driver IC controls driving of the head body. the driver IC is mounted on the flexible substrate, and the flexible substrate is electrically connected to the head body. The heat dissipation plate dissipates heat generated by the driver IC. The pressing member presses the driver IC against the heat dissipation plate. The heat dissipation plate and the pressing member are fixed to each other at a center portion of the head body in the longitudinal direction thereof.
(2) The liquid droplet discharge head according to (1) above may further include a head cover (e.g., the head cover 40) attached to the head body, and the heat dissipation plate and the head cover may be fixed to each other at both of end portions of the head body in the longitudinal direction thereof.
(3) In the liquid droplet discharge head according to (1) or (2) above, a plurality of the driver ICs may be mounted on the flexible substrate, and the heat dissipation plate and the pressing member may be fixed to each other at a position between two of the driver ICs adjacent to each other.
(4) In the liquid droplet discharge head according to any one of (1) to (3) above, the flexible substrate may include a through hole (e.g., the through hole 31a), and the heat dissipation plate and the pressing member may be fixed to each other through the through hole.
(5) In the liquid droplet discharge head according to (4) above, the flexible substrate may include a slit (e.g., the slit 31s), one end of the slit being connected to the through hole.
(6) In the liquid droplet discharge head according to (4) above, the through hole may be closed in a plane of the flexible substrate.
(7) In the liquid droplet discharge head according to any one of (4) to (6) above, a width of the through hole in a direction orthogonal to the longitudinal direction may be larger than a width of the through hole in the longitudinal direction.
(8) In the liquid droplet discharge head according to any one of (4) to (7) above, a plurality of the driver ICs may be mounted on the flexible substrate, and the through hole may be provided at a position between the driver ICs adjacent to each other.
(9) The liquid droplet discharge head according to any one of (1) to (8) above may further include a head cover attached to the head body. The heat dissipation plate and the head cover may be fixed to each other by a fixing member (e.g., the fixing member 50) including a head, and the heat dissipation plate may include a recess (e.g., the recess 47) configured to accommodate the head.
(10) In the liquid droplet discharge head according to any one of (1) to (9) above, the heat dissipation plate and the pressing member may be fixed to each other by a fixing member including a head, and the heat dissipation plate may include a recess configured to accommodate the head.
(11) In the liquid droplet discharge head according to any one of (1) to (10) above, the head body may include a channel member including a plurality of the discharge holes, a branched channel member (e.g., the branched channel member 51) positioned on the channel member and including a branched channel connected to the channel member, and an anchor (e.g., the anchors 61c, 62c, and 63d) directly or indirectly fixed to the branched channel member. The heat dissipation plate and the anchoring portion may be fixed to each other at both of end portions of the head body in the longitudinal direction thereof.
(12) In the liquid droplet discharge head according to (11) above, the anchors may be provided at both of end portions of the pressing member in the longitudinal direction of the head body.
(13) The liquid droplet discharge head according to (11) above may include a wiring board (e.g., the wiring board 32) electrically connected to the flexible substrate; and a plurality of support members (e.g., the support members 60) supporting the wiring board. The plurality of support members include a first support member (e.g., the first support member 61) supporting one end portion of the wiring board in the longitudinal direction of the head body, a second support member (e.g., the second support member 62) supporting another end portion of the wiring board in the longitudinal direction of the head body. The anchors may be provided at the first support member and the second support member.
(14) The liquid droplet discharge head according to (13) above may include two of the heat dissipation plates positioned at both of end portions of the head body in a width direction thereof, at least two first male screws (e.g., the first male screws 90) configured to be inserted into one of the two heat dissipation plates, and at least two second male screws (e.g., the second male screws 91) configured to be inserted into another one of the two heat dissipation plates. Each of the first support member and the second support member may include a tube (e.g., the tube 67) having both ends open in the width direction of the head body, a screw groove being formed in an inner peripheral surface of the tube. The first male screw and the second male screw may be fastened to the same tube.
(15) The liquid droplet discharge head according to any one of (11) to (14) above may further include a sheet member (e.g., the sheet member 70) made of a resin and configured to join the heat dissipation plate and the head body.
(16) A liquid droplet discharge head may include a head body including a channel member comprising a plurality of discharge holes configured to discharge liquid droplets, and a branched channel member positioned on the channel member and comprising a branched channel connected to the channel member. The liquid droplet discharge head may further include a driver IC configured to control driving of the head body, a flexible substrate on which the driver IC is mounted, the flexible substrate being electrically connected to the head body, a heat dissipation plate configured to dissipate heat generated by the driver IC, and an anchor directly or indirectly fixed to the branched channel member. The heat dissipation plate and the anchor may be fixed to each other at both of end portions of the head body in a longitudinal direction thereof.
(17) The liquid droplet discharge head according to (16) above may include a pressing member configured to press the driver IC against the heat dissipation plate. The anchors may be provided at both of end portions of the pressing member in the longitudinal direction of the head body.
(18) The liquid droplet discharge head according to (16) above may include a wiring board electrically connected to the flexible substrate, and a plurality of support members supporting the wiring board. The plurality of support members may include a first support member supporting one end portion of the wiring board in the longitudinal direction of the head body, and a second support member supporting another end portion of the wiring board in the longitudinal direction of the head body. The anchors may be provided at the first support member and the second support member.
(19) The liquid droplet discharge head according to (18) above may include two of the heat dissipation plates positioned at both of end portions of the head body in a width direction of the head body, at least two first male screws inserted into one of the two heat dissipation plates, and at least two second male screws inserted into another one of the two heat dissipation plates. Each of the first support member and the second support member may include a tube having both ends open in the width direction of the head body, a screw groove being formed in an inner peripheral surface of the tube. The first male screw and the second male screw may be fastened to the same tube.
(20) The liquid droplet discharge head according to any one of (16) to (19) above may further include a sheet member made of a resin and configured to join the heat dissipation plate and the head body.

Note that the embodiments disclosed herein are exemplary in all respects and not restrictive. The above-described embodiments can be embodied in a variety of forms. The above-described embodiments may be omitted, substituted or modified in various forms without departing from the scope and spirit of the appended claims.

1. A liquid droplet discharge head comprising:
a head body comprising a plurality of discharge holes configured to discharge liquid droplets;
a driver IC configured to control driving of the head body;
a flexible substrate on which the driver IC is mounted, the flexible substrate being electrically connected to the head body;
a heat dissipation plate configured to dissipate heat generated by the driver IC; and
a pressing member configured to press the driver IC against the heat dissipation plate, wherein
the heat dissipation plate and the pressing member are fixed to each other at a center portion of the head body in a longitudinal direction of the head body.

2. The liquid droplet discharge head according to claim 1, further comprising
a head cover attached to the head body, wherein
the heat dissipation plate and the head cover are fixed to each other at both of end portions of the head body in the longitudinal direction of the head body.

3. The liquid droplet discharge head according to claim 1, wherein
a plurality of the driver ICs are mounted on the flexible substrate, and
the heat dissipation plate and the pressing member are fixed to each other at a position between two of the driver ICs adjacent to each other.

4. The liquid droplet discharge head according to claim 1, wherein
the flexible substrate comprises a through hole, and
the heat dissipation plate and the pressing member are fixed to each other through the through hole.

5. The liquid droplet discharge head according to claim 4, wherein
the flexible substrate comprises a slit, one end of the slit being connected to the through hole.

6. The liquid droplet discharge head according to claim 4, wherein
the through hole is closed in a plane of the flexible substrate.

7. The liquid droplet discharge head according to claim 4, wherein
a width of the through hole in a direction orthogonal to the longitudinal direction is larger than a width of the through hole in the longitudinal direction.

8. The liquid droplet discharge head according to claim 4, wherein
a plurality of the driver ICs are mounted on the flexible substrate, and
the through hole is provided at a position between the driver ICs adjacent to each other.

9. The liquid droplet discharge head according to claim 1, further comprising
a head cover attached to the head body, wherein
the heat dissipation plate and the head cover are fixed to each other by a fixing member comprising a head, and
the heat dissipation plate comprises a recess configured to accommodate the head.

10. The liquid droplet discharge head according to claim 1, wherein
the heat dissipation plate and the pressing member are fixed to each other by a fixing member comprising a head, and
the heat dissipation plate comprises a recess configured to accommodate the head.

11. The liquid droplet discharge head according to claim 1, wherein
the head body comprises
a channel member comprising a plurality of the discharge holes,
a branched channel member positioned on the channel member and comprising a branched channel connected to the channel member, and
an anchor directly or indirectly fixed to the branched channel member, and
the heat dissipation plate and the anchoring portion are fixed to each other at both of end portions of the head body in the longitudinal direction of the head body.

12. The liquid droplet discharge head according to claim 11, wherein
the anchors are provided at both of end portions of the pressing member in the longitudinal direction of the head body.

13. The liquid droplet discharge head according to claim 11, comprising:
a wiring board electrically connected to the flexible substrate; and
a plurality of support members supporting the wiring board, wherein
the plurality of support members comprise
a first support member supporting one end portion of the wiring board in the longitudinal direction of the head body,
a second support member supporting another end portion of the wiring board in the longitudinal direction of the head body, and
the anchors are provided at the first support member and the second support member.

14. The liquid droplet discharge head according to claim 13, comprising
two of the heat dissipation plates positioned at both of end portions of the head body in a width direction of the head body;
at least two first male screws configured to be inserted into one of the two heat dissipation plates; and
at least two second male screws configured to be inserted into another one of the two heat dissipation plates, wherein
each of the first support member and the second support member comprises a tube having both ends open in the width direction of the head body, a screw groove being formed in an inner peripheral surface of the tube, and
the first male screw and the second male screw are fastened to the same tube.

15. The liquid droplet discharge head according to claim 11, further comprising
a sheet member made of a resin and configured to join the heat dissipation plate and the head body.

16. A liquid droplet discharge head comprising:
a head body comprising
a channel member comprising a plurality of discharge holes configured to discharge liquid droplets, and
a branched channel member positioned on the channel member and comprising a branched channel connected to the channel member;
a driver IC configured to control driving of the head body;
a flexible substrate on which the driver IC is mounted, the flexible substrate being electrically connected to the head body;
a heat dissipation plate configured to dissipate heat generated by the driver IC; and
an anchor directly or indirectly fixed to the branched channel member, wherein
the heat dissipation plate and the anchor are fixed to each other at both of end portions of the head body in a longitudinal direction of the head body.

17. The liquid droplet discharge head according to claim 16, comprising
a pressing member configured to press the driver IC against the heat dissipation plate, wherein
the anchors are provided at both of end portions of the pressing member in the longitudinal direction of the head body.

18. The liquid droplet discharge head according to claim 16, comprising:
a wiring board electrically connected to the flexible substrate; and
a plurality of support members supporting the wiring board, wherein
the plurality of support members comprises
a first support member supporting one end portion of the wiring board in the longitudinal direction of the head body, and
a second support member supporting another end portion of the wiring board in the longitudinal direction of the head body, and
the anchors are provided at the first support member and the second support member.

19. The liquid droplet discharge head according to claim 18, comprising:
two of the heat dissipation plates positioned at both of end portions of the head body in a width direction of the head body;
at least two first male screws inserted into one of the two heat dissipation plates; and
at least two second male screws inserted into another one of the two heat dissipation plates, wherein
each of the first support member and the second support member comprises a tube having both ends open in the width direction of the head body, a screw groove being formed in an inner peripheral surface of the tube, and
the first male screw and the second male screw are fastened to the same tube.

20. The liquid droplet discharge head according to claim 16, further comprising
a sheet member made of a resin and configured to join the heat dissipation plate and the head body.
